(19) United States
(12) Patent Application Publication
(10) Pub. No.: US 2002/0184114 A1
(43) Pub. Date: Dec. 5, 2002

(54) Method of partnership for furniture manufacturers, carpenters, craftsmen, artists and bed and breakfasts, country inns and small hotels

(76) Inventor: Scott Jorgensen, Tampa, FL (US)

Correspondence Address: GREENBERG & LIEBERMAN, 314 PHILADELPHIA AVE., TAKOMA PARK, MD, 20912, US

(21) Appl. No.: 09/683,188

(22) Filed: Nov. 29, 2001

Related U.S. Application Data
(60) Provisional application No. 60/294,813, filed on May 31, 2001.

(51) Int. Cl. G06F 17/60

(52) U.S. Cl. 705/27

(57) ABSTRACT

A business method intended to partner furniture manufacturers, carpenters, craftsmen, artisans, and bed and breakfast, country inns and small hotels to showcase both businesses equally. The business method allows growth of both the bed and breakfast inns and the furniture manufacturers, by directed advertising through web sites and real life display and use of the furniture. The method brings museum replica fine furniture to the use of small inns giving both companies the added advertising power of linked sites. The method allows all bed and breakfast”s rooms to become possible furniture showrooms, whether the piece is actually produced by an associated craftsman or is a real antique that can be replicated by the craftsmen. Bed and breakfasts, country inns and small hotels can expand their services to include furniture sales and the craftsmen, artisans, and carpenters have additional showrooms for their work.

### CROSS REFERENCE TO RELATED APPLICATIONS

Priority is hereby claimed to provisional patent application serial No. 60/294,813 filed on May 31, 2001.

### BACKGROUND OF INVENTION

The present invention is a business method for connecting furniture manufacturers, carpenters, craftsmen, and artists with bed and breakfasts, country inns, and small hotels to showcase both businesses equally.

Making furniture is an age-old profession, and selling furniture is an age-old business. Before the Industrial Revolution, European furniture was simply made and sold by one company and/or one person directly to the consumer. A craftsman in this time period would display a few items in his home or shop, and make the furniture to each customer”s specifications. London cabinetmakers were among the first to achieve success through guilds. The guilds provided a system of organization, education, advancement, insurance and protection for their members. Guilds allowed participants to control their own association, workplace, market for their services, and their relationship to local and regional governments.

In Central and South America there is an abundance of natural materials and carpenters, but there is a lack of concentrated market. The furniture craftsmen in this region provide goods suitable for sale in their local market. There is some industrialization and building of factories in these areas that follow many of the management techniques in use in the United States, Europe, and Japan. However the U.S. furniture manufacturers, in particular North Carolina companies, dominate the global furniture industry. It is extremely difficult for a small non-U.S. furniture manufacturer to penetrate the U.S. furniture market.

Two hundred years after the Industrial Revolution, individual craftsmen still exist in Central and South America as a major source of furniture. Also in many areas in Central and South America the style of living is still very close to that of the Middle Ages in Europe. Small carpenter shops in the home are common and many people do some type of business from their homes. For example, in the small city of San Benito, Guatemala one can easily walk and visit over 25 home based carpenter shops. Within driving distance are hundreds of carpenters in a 50-mile radius of San Benito.

In modern times, economies of scale provide for networks between manufacturers, distributors, and retailers. In short, one company manufactures the product to be sold; a second company distributes the product once finished; and a third company is responsible for moving the product into the hands of the consumer. There is always the lingering problem of how to organize the system between the manufacturer and the seller so that more of the product can be sold at the most profit. With use of the Internet, new business models emerge that provide manufacturers a direct route to sell to consumers. Each of these companies seeks to establish an advantage in the market by utilizing new technologies to increase productions and marketing over the Internet. However Internet marketing alone has not had reliable success, as is shown by the rapid failure of “dot com”companies.

One approach to operational efficiency is employing an inventory monitoring system. Currently, there are inventory control systems for furniture businesses that catalogue various options available to customers, and that keep track of all inventory for in office use. In concept, such systems are good so that the seller can inform the customer about which pieces of furniture can be delivered in a reasonable period of time. However, these systems are often not available to the customers, and in the instances where the public is allowed to access these databases, there are not pictures available for each possible combination of upholstery and furniture style. Even so, inventory control systems are merely a method of organizing furniture stocks. There is no bridge between the stocks of furniture ready to be sold and actual selling to the consumer; shoppers do not like to simply sift through names and products in stock, but shoppers like to look, touch, and feel furniture. Essentially, there is no factor responsible for ensuring that a sale takes place because the shopper is isolated from the product. Moreover, there is no agent that causes the shopper to be more inclined to purchase furniture because the shopper cannot appreciate the furniture product in person. These systems do not address the human aspect of selecting and purchasing items, or personal referrals and recommendations.

There are also floor display systems available for retail spaces in which display areas feature furniture in a home-type format. These are only displays, however, and do not provide the consumer with a clear view of what the furniture will look like in a true living environment. The lighting in a floor display venue option is far from the type of lighting achieved in the context of the consumer”s home. Further, the sheer amount of furniture available in floor displays detracts from the consumer”s ability to focus and study any piece of furniture in detail. Additionally, floor display systems are limited by space so that few pieces of a furniture line can be shown together, and thus, the consumer must imagine or guess as to various combinations of furniture and fabric.

A normal extension of the furniture showroom has been the proliferation of furniture manufacturer web pages. The web pages display furniture in a “piece by piece” format or in an online controlled setting, such as a simulated furniture show room or a simulated retail display. Links can be incorporated into the furniture manufacturer web pages so that customers looking for a particular piece of furniture can quickly go to retailers which carry the piece of furniture. However, these links cannot display the furniture in the context of a lived in environment, and thus, the customers cannot appreciate the texture of fabrics, the natural coloration of wood, and the actual size of a piece of furniture. Moreover, publishing reasonably sized photos of products on a web page force the furniture manufacturer to sacrifice image quality, and thus, appreciation of the furniture in the image is difficult.

Similar to furniture store displays are model home furniture displays. Model homes for a subdevelopment or neighborhood are not concerned with conveying information about furniture, or even providing information so that a consumer can purchase furniture. The main focus of model home furniture displays is to sell homes—as opposed to showing the furniture. Therefore, a consumer cannot determine how the furniture will wear through use, cannot appreciate a furniture piece in a price context, and can definitely not determine how to purchase the furniture.

U.S. Pat. No. 3,945,476 issued to Levitz, on Mar. 23,1976 shows a Retail Furniture Display and Sales Facility. Levitz” invention is unlike the present invention because it is a photograph display system with samples for different types of fabric, and wood, it does not provide for a partnership between furniture producers or retailers and anyone outside of the furniture business. It does not give consumers a real world example of the furniture being used so that they may have a clear view of the design and desirability of the furniture.

U.S. Pat. No. 3,846,947 issued to Short on Nov. 12, 1974 shows a Combination Warehouse-Retail Sales Facility. Short”s invention is unlike the present invention because it is a lay out plan for warehouse-retail facilities that divides the floor in elongated rows to separate customers from machinery, it does not provide a business partnership with another business, and does not provide for Internet display advertising. Also, it does not attempt to bring a craftsman into a relationship with the consumer, as does the present invention.

U.S. Pat. No. 4,887,208 issued to Schneider, et al., on Dec. 12, 1989 shows a Sales and Inventory Control System. Schneider”s invention is unlike the present invention because it is a computer network between the retailer of the furniture and the manufacturer of the furniture, it does not involve bed and breakfast inns, it is not an inventory system available over the Internet, and it does not give the consumer a real life setting of the furniture as does the present invention.

U.S. Pat. No. 5,918,214 issued to Perkowski on Jun. 29,1999 shows a system and method for finding product and service related information on the Internet. Perkowski”s invention is unlike the present invention because it is a system of finding products or services over the Internet using UPC or USN codes, or registered service or trademarks, which link the user to a site or advertisement for the product or service. It does not provide a catalogue resource for users to see a piece of furniture in an “in use” environment, and does not provide a means for the user to feel, see and experience the furniture or other product before purchasing. Also it does not provide a method of establishing a relationship between producers and consumers as does the present invention.

U.S. Pat. No. 5,970,472 issued to Allsop, et al., on Oct. 19,1999 shows a method for performing electronic commerce on the Internet providing links from product manufacturers to authorized dealers where the authorized dealer provides a custom order interface for the manufacturer”s products. Allsop”s invention is unlike the present invention because it is a database system primarily for manufacturer”s to access approved dealers of their product, in which the database supplies codes for the authorized dealers. It does provide links for the general public to view online catalogues of possible merchandise, and it has no method for providing the possible buyer with a method of feeling, using and experiencing the quality of the product before purchasing the product.

U.S. Pat. No. 6,029,141 issued to Bezos, et al. on Feb. 22, 2000 shows an Internet based customer referral system. Bezos” invention is unlike the present invention because it does not allow the associates to have full participation in the product, with ordering, delivery, and customer support. Bezos” invention does not provide the buyer with a try before you buy option for the products, and does not provide the ability or a space for the possible buyer to physically see the product, or a similar product before purchase. Bezo”s invention provides an added a new static viewable element of an existing business relationship. It does not provide a system for establishing new business relationship. Bezo”s invention provides only product reviews, product ratings, and not tactile or in person information for a consumer to make their purchase decision.

U.S. Pat. No. 6,052,669 issued to Smith, et al. on Apr. 18, 2000 shows a graphical user interface supporting method and system for remote order generation of furniture products. Smith”s invention is unlike the present invention because it is a system for user”s to enter data about what they need in office furniture and the data is extrapolated to determine what types of office furniture offered best suits their needs. It does not provide the user with an “in use” environment where they may sample the furniture before buying. It also does not provide a system for a partnership between two companies to showcase the furniture and ultimately create more business for each of the partners, by providing a sampling market for the furniture manufacturer and the bed and breakfast.

U.S. Pat. No. 6,055,514 issued to Wren on Apr. 25, 2000 shows a system for marketing food and services using a computerized central and remote facility. Wren”s invention is unlike the present invention because it does not provide potential buyers places to sample the products in a real life environment, and it is intended for food service industries instead of the antiques, bed and breakfast, or furniture industries.

U.S. Pat. No. 6,064,979 issued to Perkowski on May 16, 2000 shows a method of and system for finding and serving consumer product related information over the Internet using manufacturer identification numbers. Perkowski”s invention is unlike the present invention because it is a UPN and MIN based system in which the consumer will search for a wanted product, and then upon clicking on the item, they will be transferred to the manufacturer”s web page, by a link from the UPN to the MIN and thus the manufacturer”s web site. Perkowski”s invention also has no method of partnership between non-related business such as the partnership between a furniture manufacturer and a bed and breakfast owner, and it does not provide the user with a space to experience the products in an “in use” environment.

In the autumn of 1995, Thomasville Furniture Company and YBR Marketing issued a study for marketing furniture to Bed and Breakfasts. It provides demographic information and analysis for bed and breakfast owners and companies that wish to market to bed and breakfast guests. This study does not infer a long term relationship between the bed and breakfast, and the artisans, and does not provide for a relationship between the guests of the inns and the artisans who make the furniture.

U.S. Pat. No. 6,070,042 issued to McDonough, et al. on May 30, 2000 shows a virtual customer sales and service center and method. McDonough”s invention is unlike the present invention because it is a system for receiving customer complaints and questions via telephony and collecting information about the customer from data transmitted by use of the telephony. McDonough”s invention does not include a process for a customer to have an in use before you buy experience with the merchandise; it does not cater specifically to the antique, furniture, or bed and breakfast owners and does not provide a partnership between two companies, but is instead only a method of customer service and sales for one company.

U.S. Pat. No. 6,115,641 issued to Brown, et al. on Sep. 5, 2000 shows systems and methods for facilitating the exchange of information between separate business entities. Brown”s invention is unlike the present invention because it is a real time method of updating distributor”s catalogues at the same time as the manufacturer updates their in house catalogue. It does not provide for customers to have an “in use” experience with the product or products.

None of the concepts above allow the consumer to view the furniture in an “in use” setting. Therefore a need has been established for a display environment that allows the consumer to do the following: (1) to view, in person, the furniture in a setting in which the furniture is being used; (2) to have a chance to use the furniture firsthand; (3) to see various types of styles and upholstery options available for furniture in an easier venue or method than offered in a conventional retail facility; (4) to have simple purchasing access; and (5) to establish a relationship with a producer of furniture.

### SUMMARY OF INVENTION

The present invention is a business method that incorporates a partnership between fine furniture manufacturers, carpenters, craftsmen, artists and bed and breakfasts, country inns, and small hotels. Included in the business method are a (1) personal values strategy, (2) an organizational and communication strategy, (3) a marketing and sales strategy, (4) a products and services strategy, and (5) an environmental strategy. The present invention employs the Internet as well to assist in communications between producers, for sales and advertising, and for management of the business processes. An integral component of all of the above strategies is incorporation of links from bed and breakfast web sites to furniture manufacturer web sites and links from furniture manufacturer web sites to bed and breakfast web sites. Additionally included is a system of cataloguing and developing a search engine for the specific styles and types of furniture that makes up the millions of digital photos that are currently used by bed and breakfast web sites for marketing rooms for rent.

Each Bed and Breakfast wants to have concise and up to date marketing over the Internet to expand their market and exposure to their possible customers. The present invention has a method for taking existing photos on the web site and divides them into each of the room”s furniture components. The photographs of the individual pieces of furniture are linked to the larger picture so that when the user clicks on the piece of furniture they have a close up view of the furniture. If the consumer is interested in the pieces of furniture, they can then use links to reach the producer of the furniture.

The use of existing photos on a Bed and Breakfast”s web site to advertise the furniture or other items viewed in addition to the attempt to rent the room by advertising the pictures of the room. This is a novel implementation as current technology is used to rent the room only, and there is no established partnership between bed and breakfasts and furniture producers or craftsmen. Also the present invention has a mechanism to display existing furniture, such as antiques, and connect the consumer with a craftsman who could recreate the furniture to the consumer”s specifications.

The partnership between the bed and breakfasts and the craftsmen also includes a method for the consumer to search the Internet for specific types of furniture and determine where one could go to feel, use and eventually purchase the showcased furniture. There are currently search engines that a consumer could use to find retailers of particular types of furniture, but none of these systems allow a consumer to know where they could go to an inn and see the furniture in an in use environment, as does the present invention.

The personal values strategy and the craftsmen ownership strategy instill a sense of pride that the craftsmen receive from their work. The marketing strategy allows both companies to widen their customer base. The product and services strategy allows the bed and breakfasts and the furniture manufacturers to supply the consumers with the most up to date options in furniture. The consumer has hands on experience with the furniture before buying.

According to the present invention, the consumer can appreciate furniture actually being used in an inn. Thus, the consumer visits the bed and breakfast in order to easily sample furniture and to see craftsmanship in detail and in person. It also draws more business to both the bed and breakfasts and the furniture manufacturers. Consumers who like the furniture and have visited the furniture producers” web site can automatically be taken to the web site of an inn using the style of furniture that they are interested in and they may visit the inn. In the same aspect visitors to the inn”s web site can easily access the site of the furniture manufacturers to learn more about the furniture and purchasing options.

### BRIEF DESCRIPTION OF DRAWINGS

FIG. 1 shows a flowchart of registration of the separate business entities into the database.

FIG. 2 shows the possible chains of sale that a customer could proceed through in the present method.

FIG. 3 shows what information each type of entity enters in the database.

### DETAILED DESCRIPTION

The present invention is a method of partnership between bed and breakfasts, country inns, small hotels and furniture manufacturers, carpenters, craftsmen, and artisans. The method includes a definitive series of steps for each partner to partake in to further the partnership and the strength of each business. There are five distinct strategies in the method for each side of the partnership as part of the business strategy. The five steps are a) personal values strategy, b) an organizational and communications strategy, c) a marketing and sales strategy, d) a product and services strategy and, e) an environmental strategy.

The Personal Values Strategy is designed to instill pride in the work, the company, and the community. The goal of the Personal Values Strategy is to develop craftsman”s ability to strive to do the best job that they can, always strive to improve their ability, and to always be ready for their next challenge. This strategy teaches the values of honor and respect for oneself and for others. The Personal Values Strategy is integral, because the workers need to be able to perform at a level equal to or surpassing that of factory produced furniture in the U.S. The Personal Values Strategy gives the artisans a sense of pride in their community and their work, to further the quality of production.

A portion of the Personal Values Strategy includes encouraging the craftsmen to volunteer with children in programs such as scouting. Boy and Girl Scouting can positively influence young men to learn discipline, leadership, and honesty, which can easily be used by the children as they grow to make their lives and communities a better place. By adults teaching the values of Scouting to children in local programs, those same adults will learn positive personal values themselves.

The Personal Values Strategy also teaches social and personal responsibility to the craftsmen of the partnering firms. This strategy can be implemented by use of local volunteer organizations and craftsmen time. In order to implement the Personal Values Strategy, there is an educational system. Part of the Personal Values Strategy is the equal opportunity of all craftsmen at any level in the organization for growth and development. In this manner the communities in which the system is installed profit in monetary and non-monetary ways. The community benefits in non-monetary manners due to an increase in volunteer force, and a higher respect in their community can lead to safer and crime free environments. The making of museum quality antique reproductions requires the highest levels of attention to details and design. Quality products sell themselves to some extent through word of mouth or personal referrals. Giving craftsmen valuable volunteer and education experiences, leads to further pride in the work, and better quality work.

The Organizational and Communications Strategy includes concise explanations of organizational structure, processes, resources, policies and procedures. The organizational method of the business is one of craftsman owned and controlled structure. This creates a situation of pride and accountability in the work that cannot be achieved in a basic employee employer relationship. If each craftsman feels as though they have a say in what happens in the company on each level the workmanship is better and the infrastructure can move at a smoother pace than in non-craftsman controlled companies. Also craftsman ownership leads to pride in the work which cannot be attained by jobs that merely provide income. The quality of the work is better than that of companies that do not have craftsman ownership programs because of the sense of pride established by owning part of the work and the proceeds. The Organizational and Communications Strategy is integral to the method because it gives carpenters or artisans who are accustomed to working for themselves, an expanded market and the ability to still have a say in ownership related decisions. It also keeps each of the particular workers with a sense of responsibility, ownership and pride for each piece of work and a network of affiliated services at their fingertips.

Much like the guilds, the craftsman ownership structure will be similar in its objectives. Traditional guilds were hierarchical and based on an apprenticeship system. The present craftsman ownership strategy divides members into masters, journeymen, and apprentices but the system will rely heavily upon personal achievement of the craftsmen and customer options to determine their position in the organization. The strategy is to bring the opportunity to the craftsmen and they can decide how far they go.

The goal of the Marketing and Sales Strategy is to reach the target market for the products and to communicate to the possible customers the quality of the products and the difference between museum quality, fine furniture and mass produced furniture to achieve appropriate sales. In order to achieve the Marketing and Sales Strategy, the products are marketed in a conventional and unconventional marketing. For conventional marketing, independent designers, decorators and architects can be reached through trade publications and over the Internet. For unconventional marketing, the products can be marketed to the millions of guests in the thousands of bed and breakfasts, country inns and small hotels each year in the United States. The partnership between the artisans and the bed and breakfasts allows the craftsmen to use the rooms available in these small hotels as livable showrooms for the furniture. Many of the rooms are already showcased on the Internet through the Bed and Breakfast”s web sites. The artisan”s and craftsmen can reproduce the same furniture or accessories showcased in those rooms. Additional development of the market includes links from the furniture pictures on the Bed and Breakfast”s web sites to the contact information for the artisans and craftsmen”s web sites or contact information. The Marketing and Sales Strategy will allow the carpenters or artisans to have an expanded advertising market, and infinite amounts of potential customers through use of the Internet, and showcasing in bed and breakfasts.

The method, where possible, will bring the consumers and the artisan or craftsman that creates the furniture together through email, video conferencing, digital photographs, and other medium so that each participant feel ownership and involvement even before the piece is started. Due to the remote locations of many of the furniture producers the method includes professionals in a central location who can act as translators, and provide localized technology for the artisans to use and virtually meet their customers. Currently, there are existing land and cellular networks throughout most small cities in Central and South America to build the communication systems to bring producers and consumers together.

The Marketing and Sales Strategy includes a partnership between bed and breakfast inns, country inns, small hotels and the fine furniture manufacturers, carpenters, craftsmen, and artisans. In example: 1) the fine furniture manufacturer supplies the inn with museum replica quality furniture, which is used in the suites, 2) the furniture manufacturers benefit from the venture in that they have a showcase space in which the patrons of the inns get to use the furniture, and the inns are supplied with rare furniture that will set them apart from the other inns in business.

The Product and Services Strategy incorporates use of Central and South American labor and lumber to reduce manufacturing costs and add substantial industry to remote regions of Central and South America. Central and South American labor can be used easily, due to the low cost of living in these areas, and will allow craftsmen who work from their homes to continue to do that and still market to foreign markets. Included with the Product and Services Strategy and the Organizational and Communications Strategy is to bring the artisan and guests together in a producer and consumer relationship.

To accomplish the Products and Services Strategy, centrally located plants, transportation networks, research departments, integrated software and home-based shops are needed. The centrally located plants could contain a lumberyard, a kiln, raw material preparation area, raw material storage, finish shops, packaging shops, finished products storage, finished products storage, administration offices, training facilities, and shipping and receiving docks. The centralized plant or a group of entities acting simultaneously functions as a conduit to the craftsmen”s home based shops and the global market. The centralized plant or a group of entities acting simultaneously are called the Production Conduit or Canalizaci ó n para Producto or CP for short, and will serve thousands of craftsmen in the area. The craftsmen will be able to view and/or utilize any of the components of the CP. Artisans are able to obtain correctly dried and treated lumber, rent or use industrial equipment, have access to proper packaging materials, training facilities and materials, and to use the communication equipment of the CP. All components of the CP will be focused on providing the best quality products and services for the customers. The Products and Services strategy in conjunction with the CP will provide the artisans with expanded resources for their products and a central meeting place for the artisans to meet and collaborate.

It should be noted that some forms of centralized plants exist throughout Central and South America. The present method intends to utilize those existing structures and bring those centralized plants into partnerships with the Bed and Breakfast, Country Inns and small hotel industry. Through integrated communications and software, the present invention will bring together currently separated businesses and entities to create a production conduit. A production conduit can be a single building or spread among separate entities within a community. Existent in Central and South America currently are lumberyards, kilns, Internet cafes, small factories, trade schools, freight forwarders, truckers, warehouses and home shops. Through the Internet, software, communications and partnerships, these entities can work together.

The transportation network consolidates the products from the multiple Central and South American locations and ships them in single container shipments to the United States, more specifically to major ports on the East Coast of the U.S. The products are packaged ready for delivery to the customer, and once delivered to the ports of the U.S. the products are divided and shipped by common carriers anywhere in the U.S. The transportation network allows the artisans to reach the markets and customers accessed through the Marketing and Sales Strategy.

The research department matches photos, drawings and examples of customer requested furniture with known construction techniques, detailed drawings and product samples. Also contained are an inventory of antiques, training manuals and videos to assist the craftsmen in completing each project. As needed, the research department will provide detailed drawings of each proposed product. The research department allows each of the artisans to have the research resources of a large factory or furniture manufacturer while still keeping the integrity of work of the individual artisan.

Home based shops exist in Central and South America as they did hundreds of years ago. Keeping these shops in tact is an important goal of the present method. There are strong family values associated with the home based shops, and it is believed that the best work can be achieved in the home, instead of in a factory with administrators, supervisors and managers.

An integral Marketing and Sales Strategy included in the present method is linking pictures of the furniture as used in the suites to the web sites of both the bed and breakfasts and the furniture manufacturers; making it easier for the consumer to see the furniture in a real life setting and to contact the manufacturers or craftsmen to have their own furniture made. The Marketing and Sales Strategy is integral to the artisans because it links their work to an audience that was previously unreachable, expanding their customer base and increasing their income.

In example if a carpenter who produces hand crafted mirror frames is hired for a job through the CP to reproduce a Louis IX style frame. He would first receive a letter from the CP informing him of receipt of digital pictures, and measurements of the frame to be replicated. He would go into the CP to review the material and request additional measurements, as needed. Also the carpenter may draw a copy of what he has viewed as detail, such as a corner design. The CP can then email the questions and copy of the detail design to the customer. The customer reviews the drawings and answers any questions. After all questions have been answered the carpenter sets a price for the project after determining the cost of materials, labor and profit margin. The CP then determines the market rate for the product and determines if the product can be sold at that rate inclusive of shipping costs. The customer is notified of the price, and if the order is accepted, the carpenter begins work. The carpenter can use the CP equipment to plane the wood to the exact measurement needed for the mirror. All the hand carving is completed at the carpenter”s home shop. After the frame is completed the carpenter brings it to the CP for packaging and shipping; he receives final payment for the item. The CP”s administrative offices handle exportation of the frame to the customer, and collect any outstanding balance from the customer.

The Environmental Strategy is to educate the craftsmen and communities about the importance of recognizing the importance of their available natural resources for the protection of their future economic growth. The current market is one of export, where the natural resources, such as lumber, are exported to different countries for their use. The principle of using their own natural resources to further their economic growth has not been realized. The environmental strategy includes aggressive plans to reforest land illegally poached and burned, purchasing land for tree farming, and a public education system on the importance of the area”s natural resources. The environmental strategy allows users to learn about the resources available in their area and the most efficient ways to use and replace these resources.

The chain of process from the consumer to the furniture producer and the innkeeper can proceed as is explained in the following sentences. A consumer decides to stay in a Bed and Breakfast Inn for comfort and hospitality. They notice that the furnishings are well made, unique and fine art quality. The consumer can then sample the furniture to determine the quality. If the consumer is happy with the quality of the furniture they can contact the innkeeper who will have a direct link to the furniture producer and can inform the consumer of how to buy the furniture. The innkeeper also has the option of directing the consumer to the web sites that are linked and can direct the consumer to different furnishing options.

The first step for the consumer can be for the user the look online at fine furnishing manufacturer”s sites, or at online craftsman”s showcase. Once the customer has found a furniture style they prefer they may then follow links from that style of furniture to sites of bed and breakfasts that have that style of furniture in use in their inns. The customer may contact the bed and breakfast inns and arrange to stay in the rooms that showcase and use the style of furniture in which they are interested. In this manner the customer may sleep on the bed, or lounge on the couch, or generally use the furniture in which they are interested. The customer can also question the inn owner about local or remote craftsmen, and options that are available for these styles of furniture. Through the partnership between the furniture manufacturers and the bed and breakfast owners supplies the inn owners with the literature and knowledge necessary to allow the customer to order the furniture they want through the inn owner. In an alternate situation, the inn owners can direct the customer to a personal contact in the furniture manufacturer or dealer”s office that can then take the order of the customer for the furniture.

From another point of view the first step for the inn owner, is a desire for the use of fine furniture and/or antiques in their inn. The desire for a particular type of antiques or furniture could come from a visit to a museum or viewing the furniture online or in a physical showroom. The inn owner can then contact a fine furniture producer and together with a consultant from the fine furniture company to determine the look and feel that they desire. The fine furniture manufacturers can then produce the order, and in the meantime the web sites of the companies can be linked so that the customer has easy access to the furniture manufacturers and to the bed and breakfasts. In this manner the bed and breakfast inns and the furniture manufacturers have a broader base of possible customers.

For the bed and breakfast owner who already owns their own antique furniture can choose selected antiques for replication. The inn owner would be able to achieve the best success with this by choosing pieces that have been requested by guests in the past. In this manner the inn owner does not need to purchase new furniture but instead chooses antique furniture that can be reproduced. For these Bed and Breakfasts the marketing strategy includes hand carved boxes in each room, to hold marketing information about the furniture producers and the inns. This creates continuity of marketing techniques and gives the artisans and the inn owners further ability to increase their business. The producers guarantee the replicas and other furniture products, but the inn owners hold no liability for the replicated furniture.

From the point of view of the furniture manufacturers the first step is a desire to display their product in an “in use” environment for potential customers. The furniture manufacturer can then contact bed and breakfast owners, and supply the bed and breakfast owners with showcase quality furniture, and can then direct their potential customers to the bed and breakfasts so that they may have an environment to experience the furniture first hand.

The second strategy is to obtain detailed photographs and measurements to provide the appropriate information for reproduction. After the piece of furniture has been determined to be from a particular time period, the measurements and pictures are ample information for reproduction. The time period is needed so that the artisan may reference the construction of furniture during that time period to make the replication as close as possible to the original. Also the reproduction of these items through the partnership of the bed and breakfasts and the artisans brings antiques to the artisan they may never have seen or experienced otherwise.

The business strategy has several steps to benefit both partners. The bed and breakfast industry will have three levels of participation 1) referrals, 5% commission, 2) sales/marketing, 10% commission, 3) custom design/consulting 15% commission. These numbers are based on the bed and breakfast owner”s amount of commitment to the partnership with the artisans.

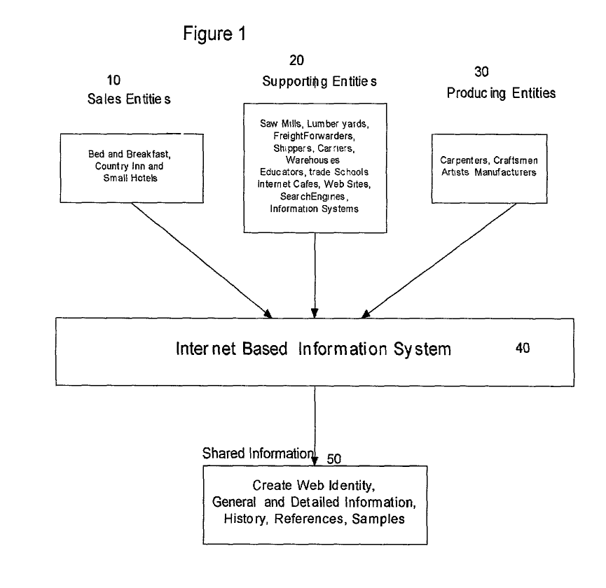

In FIG. 1, there is a detailed view of the separate types of entities and the registration process in the Internet database system. The three main types of business entities that would benefit from the method are sales entities (10), supporting entities (20) and producing entities (30). The sales entities (10) include, but are not limited to bed and breakfasts, country inns, and small hotels. The supporting entities (20) include, but are not limited to: saw mills, lumber yards, freight forwarders, shippers, carriers, warehouses, educators, trade schools, Internet cafes, web sites, search engines, and information systems. The producing entities (30) include, but are not limited to: carpenters, craftsmen, artists, and manufacturers.

The sales entities (10), supporting entities (20), and producing entities (30) would each enter their contact information over the Internet into the Internet Based Information System (40). Contact information for the entities (10, 20, and 30) would include the location and type of company, the contact person within the company, and a brief summary of the goods and/or services offered by the company. The Internet Based Information System (40) would then display the shared Information (50) about each entity (10, 20, and 30). The shared information includes but is not limited to: web identity of the entity, general and detailed information about the entity and the products and/or services offered by the entity, history, references, and samples, either in photograph or drawing format.

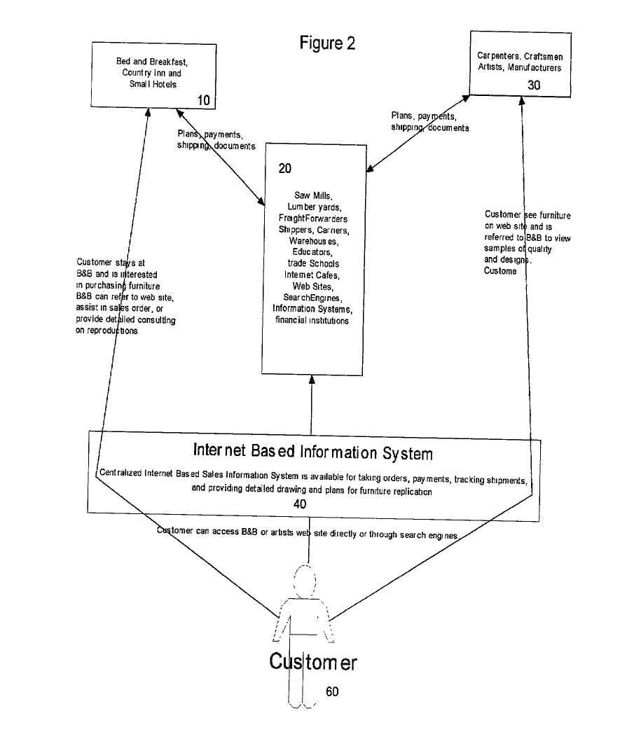

FIG. 2 shows how a customer could go through the separate section of the sales network to attain different products. The customer (60) would link to the Internet Based Information System (40). They would be able to link into the Internet Based Information System through conventional search engines by searching on bed and breakfasts, furniture or furniture suppliers. The Internet Based Information System (40) is the centralized system for taking orders, payments, tracking shipments, and provide detailed drawings of furniture, and is the system in which the sales entities (10), supporting entities (20), and the producing entities (30) register as in FIG. 1. There are two directions a customer (60) can take at this point. If they have vacationed at a bed and breakfast, country inn, or small hotel (10) they can use the Internet Based Information System (40), to connect them with the carpenters, craftsmen, artists, and manufacturers (30) of the furniture displayed where they vacationed.

Alternately, the customer (60) may view a piece of furniture they are interested in from a particular carpenter, craftsman, artist or manufacturer (30) through the Internet Based Information System (40). The Internet Based Information System (40) would direct the customer (60) to a bed and breakfast, country inn, or small hotel (10), which displays the furniture, or art of the particular carpenter, craftsman, artist, or manufacturer (30) that they are interested in. The customer (60) also has access to the supporting entities (20) through the Internet Based Information System (40). The Internet Based Information System (40) links the sales entities (10), supporting entities (20), and producing entities (30) to each other, and in contact with the customer (60).

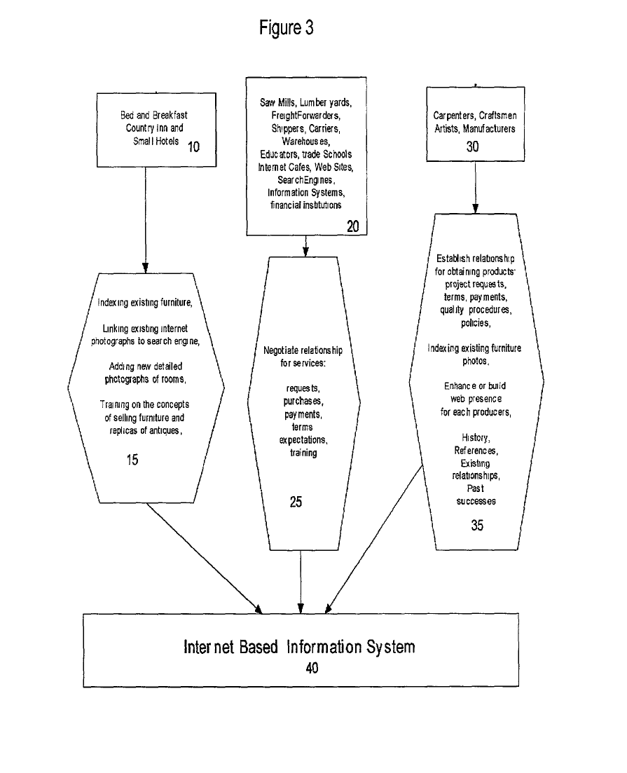

In FIG. 3, there is a detailed break down of the type of information that each entity would enter into the database. The sales entities (10) would perform the following tasks in the Internet Based Information System (40): index existing furniture, linking existing Internet photos to the database, adding new detailed photographs of rooms, and partake in training the concepts of selling furniture and replicas of antiques (15). The supporting entities (20) would perform the following tasks in the Internet Based Information System (40): negotiate relationships with the sales entities (10) and the producing entities (30) for requests, purchases, payments, terms, expectations, and training (25). The producing entities (30) would perform the following tasks in the Internet Based Information System (40): establish a relationship for obtaining products, index existing furniture photographs, enhance or build Web exposure for each producer, and enter their history, references, existing relationships and past successes through the system (35).

As is shown in FIGS. 1-3, the Internet Based Information System (40) links the entities (10, 20, 30) with each other and with the customer (60). It gives a central base for the user to receive training, information about possible partners, and to expedite the chain of process from the customer (60) to needed services and products. When an order is received, the Internet Based Information System (40) sends the information to the appropriate producing entity (30). The producing entity (30) for example a craftsman can then go to a supporting entity (20) such as an Internet Caf e or CP to access the order from the Internet Based Information System (40). The craftsman can then enter any inquiries to the customer (60) or requests for supplies to the supporting entity (20).

In other embodiments the present invention the furniture can be showcased in historic homes, museums, personal residences or other applicable venues. The web sites of these showcases could also be linked to that of the furniture manufacturer, the artisan carpenter, and/or craftspeople. In this manner all of the companies or participants can have a higher rate of visibility and possible customers.

The present invention is not limited to the sole embodiments described above, but also all embodiments within the scope of the following claims.

1. A furniture distribution method, comprising:
displaying furniture in an environment where said furniture is employed as furniture;
directing customers to visit the environment where said furniture is employed as furniture; and
providing customers with a means to contact a manufacturer of said furniture displayed in the environment where said furniture is employed as furniture.

2. The furniture distribution method of claim 1, wherein the environment where said furniture is employed as furniture is a bed and breakfast, a country inn, or a small hotel.

3. The furniture distribution method of claim 1, wherein furniture producing entities are charged with said directing of customers to visit the environment where said furniture is utilized as furniture.

4. The distribution method of claim 3, wherein the furniture producing entities are carpenters, craftsmen, artists, or manufacturers.

5. The furniture distribution method of claim 1, wherein the Internet is the means to contact a manufacturer of said furniture displayed in the environment where said furniture is employed as furniture.

6. The furniture distribution method of claim 1, further comprising linking said displaying furniture and said directing customers via link supporting entities such as saw mills, lumber yards freight forwarders, shippers, carriers, warehouses, educators, trade schools, Internet cafes, web sites, search engines, and information systems.

7. The furniture distribution method of claim 1, wherein sales entities are charged with said displaying furniture, producing entities are charged with said directing customers, and supporting entities are charged with linking said displaying furniture and said directing customers.

8. A furniture distribution method, comprising:
receiving contact information from sales entities, supporting entities, and producing entities in an information network;
receiving orders and payments from customers via the information network; and
connecting the customers with the producing entities via the information network;
wherein the supporting entities negotiate relationships with the sales entities and the producing entities for requests, purchases, payments, terms, expectations, or training.

9. The furniture distribution method, as in claim 8, wherein the sales entities partake in training the concepts of selling furniture and replicas of antiques.

10. The furniture distribution method, as in claim 8, wherein the producing entities establish a relationship for obtaining products, index existing furniture photographs, enhance or build Internet exposure for each individual producer, or enter each individual producer”s history, references, existing relationships, and past successes.

11. The furniture distribution method, as in claim 8, wherein the sales entities index existing furniture, link existing Internet photos to a database, or add detailed photographs of rooms.
